(19) United States
(12) Patent Application Publication
(10) Pub. No.: US 2023/0377359 A1
(43) Pub. Date: Nov. 23, 2023

(54) Test-Time Adaptation for Visual Document Understanding

(71) Applicant: Google LLC, Mountain View, CA (US)

(72) Inventors: Sayna Ebrahimi, Los Altos Hills, CA (US); Sercan Omer Arik, San Francisco, CA (US); Tomas Pfister, Redwood Shores, CA (US)

(73) Assignee: Google LLC, Mountain View, CA (US)

(21) Appl. No.: 18/199,129

(22) Filed: May 18, 2023

Related U.S. Application Data
(60) Provisional application No. 63/343,211, filed on May 18, 2022.

(51) Int. Cl. G06V 30/19; G06V 10/70

(52) U.S. Cl. CPC G06V 30/1912; G06V 30/19147; G06V 10/70

(57) ABSTRACT

An aspect of the disclosed technology comprises a test-time adaptation (“TTA”) technique for visual document understanding (“VDU”) tasks that uses self-supervised learning on different modalities (e.g., text and layout) by applying masked visual language modeling (“MVLM”) along with pseudo-labeling. In accordance with an aspect of the disclosed technology, the TTA technique enables a document model to adapt to domain or distribution shifts that are detected.

### CROSS REFERENCE TO RELATED APPLICATIONS

The present application claims the benefit of the filing date of U.S. Provisional Patent Application No. 63/343,211, filed May 18, 2022, the disclosure of which is hereby incorporated herein by reference.

### BACKGROUND

Models used in machine learning applications are typically trained using data from a source domain, e.g., labeled data, resulting in a pre-trained model. However, when such models are tested on, for example, customer data (“test-time”) the model is typically required to adapt to unlabeled target data. More specifically, self-supervised pre-training has been able to produce transferable representations for various visual document understanding (“VDU”) tasks. VDU seeks to extract structured information from document pages represented in various visual formats. Once a pre-trained model is fine-tuned with labeled data in a source domain, performance may be impacted when such models are applied to a new unseen target domain. This phenomenon is generally referred to as “domain shift” or distribution shift. Domain shift is commonly encountered in real-world VDU applications where training and test-time distributions are different, e.g., a new layout, unseen data, different handwriting style, etc. Such real-world applications include financial services, insurance, healthcare, or legal, where document templates used by each customer oftentimes introduce domain shift. For instance, such applications may include tax/invoice/mortgage/claims processing, identity/risk/vaccine verification, medical records understanding, compliance management, as well as others. Adapting to unseen unlabeled documents at test-time is a challenging task in document understanding.

### SUMMARY

The disclosed technology may comprise one or more of a method, process, non-transitory computer readable medium, computing device, or system. For example, the method may comprise training, via a source domain, a machine learning model to use with one or more visual document understanding (“VDU”) tasks; determining a distribution shift when the machine learning model is applied in a target domain; applying a masked visual language modeling (“MVLM”) to target domain data detected as associated with the distribution shift to produce model predictions; generating pseudo-labels using the model predictions; and adapting the machine learning model to include the pseudo-labels to produce an adapted model.

In accordance with this aspect of the disclosed technology, the method may comprise applying self-training to the machine learning model using the pseudo-labels. The method may also comprise processing the target domain data detected as associated with the distribution shift using the adapted model. The method may further comprise applying thresholding to the pseudo-labels to reduce the pseudo-labels by a given amount. In addition, applying a threshold comprises applying an entropy-based uncertainty-aware pseudo-labeling selection mechanism to determine which of the pseudo-labels are reliable.

In accordance with this aspect of the disclosed technology, the method may comprise generating the pseudo-labels on a per-batch basis. The method may also comprise processing the target domain data using a visual encoder.

As another example, the disclosed technology may comprise a method for processing one or more electronic documents. The method may include receiving the one or more electronic documents as an input data stream; applying a machine learning model to the input data stream; determining that there is a domain shift associated with the input data stream; applying masked visual language modeling (“MVLM”) to target domain data determined as associated with the domain shift to produce model predictions; adapting the machine learning model to include the pseudo-labels to produce an adapted model; and processing the input data stream using the adapted model.

In accordance with this aspect of the disclosed technology, the machine learning model is trained on source domain data that does not account for the target domain data.

Further in accordance with this aspect of the disclosed technology, the method comprises applying self-training to the machine learning model using the pseudo-labels. The method may also comprise applying threshold to the pseudo-labels to reduce the pseudo-labels by a given amount. In addition, applying the threshold comprises applying an entropy-based uncertainty-aware pseudo-labeling selection mechanism to determine which of the pseudo-labels are reliable.

In accordance with this aspect of the disclosed technology, the method may comprise generating the pseudo-labels on a per-batch basis. The method may also comprise processing the target domain data using a visual encoder. The method may further comprise processing the target domain data using an optical character recognition parser. In addition, the target domain data may comprise test-time data.

Another aspect of the disclosed technology may comprise a non-transitory computer readable medium having stored thereon instructions that, when executed by one or more computing devices, cause the one or computing devices to: determine a distribution shift when the machine learning model is applied in a target domain; apply a masked visual language modeling (“MVLM”) to target domain data detected as associated with the distribution shift to produce model predictions; generate pseudo-labels using the model predictions; and adapt the machine learning model to include the pseudo-labels to produce an adapted model. In accordance with this aspect of the disclosed technology, the instructions may cause the one or computing devices to apply self-training to the machine learning model using the pseudo-labels. Further, the instructions may cause the one or computing devices to process the target domain data detected as associated with the distribution shift using the adapted model.

### BRIEF DESCRIPTION OF THE DRAWINGS

FIG. 1 illustratively depicts an example method or process flow in accordance with one or more aspects of the disclosed technology.

FIG. 2 illustratively depicts an example method or process flow in accordance with one or more aspects of the disclosed technology.

FIG. 3 shows examples of documents labeled in accordance with one or more aspects of the disclosed technology.

FIG. 4 illustratively depicts examples of domain or distribution shift in accordance with one or more aspects of the disclosed technology.

FIG. 5 illustratively depicts an example computing device in accordance with one or more aspects of the disclosed technology.

FIG. 6 illustratively depicts a system in accordance with one or more aspects of the disclosed technology.

### DETAILED DESCRIPTION

An aspect of the disclosed technology comprises a test-time adaptation (“TTA”) technique for VDU tasks that uses self-supervised learning on different modalities (e.g., text and layout) by applying masked visual language modeling (“MVLM”) along with pseudo-labeling. The VDU tasks may include key-value extraction, entity recognition, and document visual question answering (“VQA”). MVLM is employed at test-time to make the model learn the language modality of the test data given two-dimensional positions and other text tokens, e.g., by intentionally masking out text and asking the model to make predictions. In one aspect, pseudo-labeling comprises an uncertainty-aware pseudo-labeling selection mechanism which more accurately predicts labels for new target samples. For instance, hard pseudo-labels may be generated on a per-batch basis using model predictions. The uncertainty-aware selection mechanism results in the selection of a subset of labels with low uncertainty. In this regard, the uncertainty technique is based on Shannon's Entropy. In addition, the technique makes use of class diversification to mitigate against blindly trusting the most probable class label during pseudo-label generation.

The disclosed technology also introduces various benchmarks for VDU tasks including key-value extraction, entity recognition, and document visual question answering (“DocVQA”). These benchmarks are generated using publicly available datasets by modifying them to simulate real-world adaptation scenarios.

The disclosed technology may be implemented as a methodology, method, or process in a machine learning system. The methodology, method, or process may be instantiated during test-time when new unseen data is detected as part of a set of customer data and used to apply adaptation to such data. The disclosed methodology is referred to as document test-time adaptation (“DocTTA”). The disclosed methodology leverages cross-modality self-supervised learning via MVLM, as well as pseudo-labeling, to adapt models trained on a source domain to an unlabeled target domain at test-time. From a system perspective, the disclosed technology may comprise instructions in a software module.

Unsupervised domain adaptation (“UDA”) methods attempt to mitigate the adverse effect of domain or data shifts, often by training a joint model on labeled source and unlabeled target domains that map both domains into a common feature space. However, simultaneous access to data from source and target domains may not always be feasible in VDU tasks. In addition, the training and serving may be done in different computational environments, and thus, the training data and resources may not be available.

TTA methods have been also introduced to adapt a model that is trained on source to unseen target data, without using any source data. Existing TTA methods have mainly focused on image classification tasks, while VDU remains to be unexplored, despite the clear motivations of the distribution shift and challenges for employment of standard UDA. Current TTA approaches for image classification typically use entropy minimization or pseudo-labeling combined with self-supervised contrastive learning. However, VDU significantly differs from other computer vision tasks. In VDU, information is extracted from multiple modalities (including image, text, and layout), unlike other computer vision tasks. In addition, multiple outputs (e.g., entities or questions) are obtained from the same document, creating the scenario that their similarity in some aspects (e.g., in document format or context) can be utilized. Moreover, the popular self-supervised contrastive methods in computer vision that are known to increase generalizability using image augmentation techniques are not as effective in VDU.

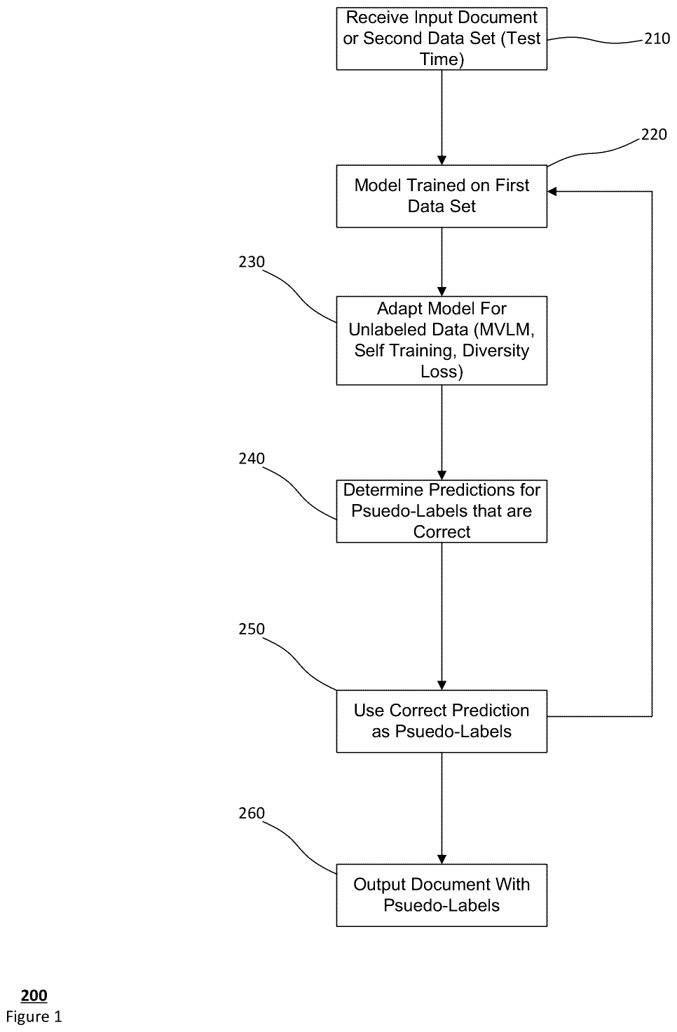

Turning now to FIG. 1, there is depicted an example of a process 200 in accordance with an aspect of the disclosed technology. The process 200, as well as any other process or method discussed herein, may be performed by a computing device. For instance, the process may be reduced to a set of instructions that cause the computing device to process input data or documents and, by performing the process, produce one or more adapted documents based on an adapted model.

As shown, the process 200 begins upon receipt of an input document or second data set at block 210. The input document or second data set comprise customer data that is to be tested on a document model, e.g., test-time data. As is discussed in more detail below, the input document or second data set will typically be received by a computing device that carries out the processing or method steps of process 200. The input document or second data set may comprise data associated with document pages that are provided by a customer and from which the customer expects certain structured data to be outputted after being processed by the computing device. The input document or second data set may be considered a target domain and may comprise, for example, data associated with documents provided by a corporation.

Assuming the documents comprise one or more W2 forms, the customer may want, for example, to extract certain financial and employee information recorded on the form. Further, let's assume that the stream of data is associated with two different types of W2 forms—a legacy form and an updated form, which includes data not provided in the legacy form. In addition, the document model used in processing the stream of data is assumed to be trained on data associated with the legacy form, e.g., data associated with a source domain, and typically comprises a machine learning model. As such, some of the data or information associated with the new form doesn't look like past data associated with the legacy form. In accordance with the disclosed technology, such new data or target data comprises unlabeled data within the document model. As one skilled in the art may appreciate, in some systems the document model may be unable to continue processing the input data stream or fail when a domain shift occurs.

The input document or second data set is fed to a model that is trained on a first data set, as shown at block 220. The first data set comprises data that is labeled in accordance with the model. As the model is trained on a first data set, any data within the second data set or data associated with the input document that is different than the first data comprises unlabeled data. The unlabeled data comprises data that represents a domain or distribution shift by the model.

Responsive to detecting a domain or distribution shift event, processing moves to block 230, where the model is adapted to account for the shift caused by the unlabeled data. The document model adapts automatically and may adapt on the fly or in real time, e.g., without any noticeable delay or performance impact. The model is adapted based on application of MVLM, self-training using pseudo-labels, and a diversity cost objective. In accordance with the disclosed technology, each of MVLM, self-training, and diversity cost comprises objective functions as part of the DocTTA methodology and system.

A framework in accordance with the disclosed methodology or system (e.g., DocTTA methodology and system) includes defining a framework (e.g., DocTTA framework) that includes a domain as a pair of distribution D on inputs X and a labeling function 1:X→Y. In accordance with the disclosed technology, we consider source and target domains. In the source domain, denoted as (Ds, ls), we assume to have a model denoted as fs and parameterized with Os to be trained on source data {xₛ⁽ⁱ⁾; xₛ⁽ⁱ⁾}ᵢ₌₁ⁿ^{ₒ}, where xₛ⁽ⁱ⁾∈Xₛ and yₛ⁽ⁱ⁾∈yₛ are document inputs and corresponding labels, respectively and ns is the number of documents in the source domain. Given the trained source model fs and leaving Xs behind, the goal of TTA is to train ft on the target domain denoted as (Dt, lt) where ft is parameterized with θt and is initialized with θs and Dt is defined over {xₛ⁽ⁱ⁾}ᵢ₌₁ⁿ^{ᵢ}∈Xₛ without any ground truth label. Algorithm 1 below provides an overview of the DocTTA methodology.

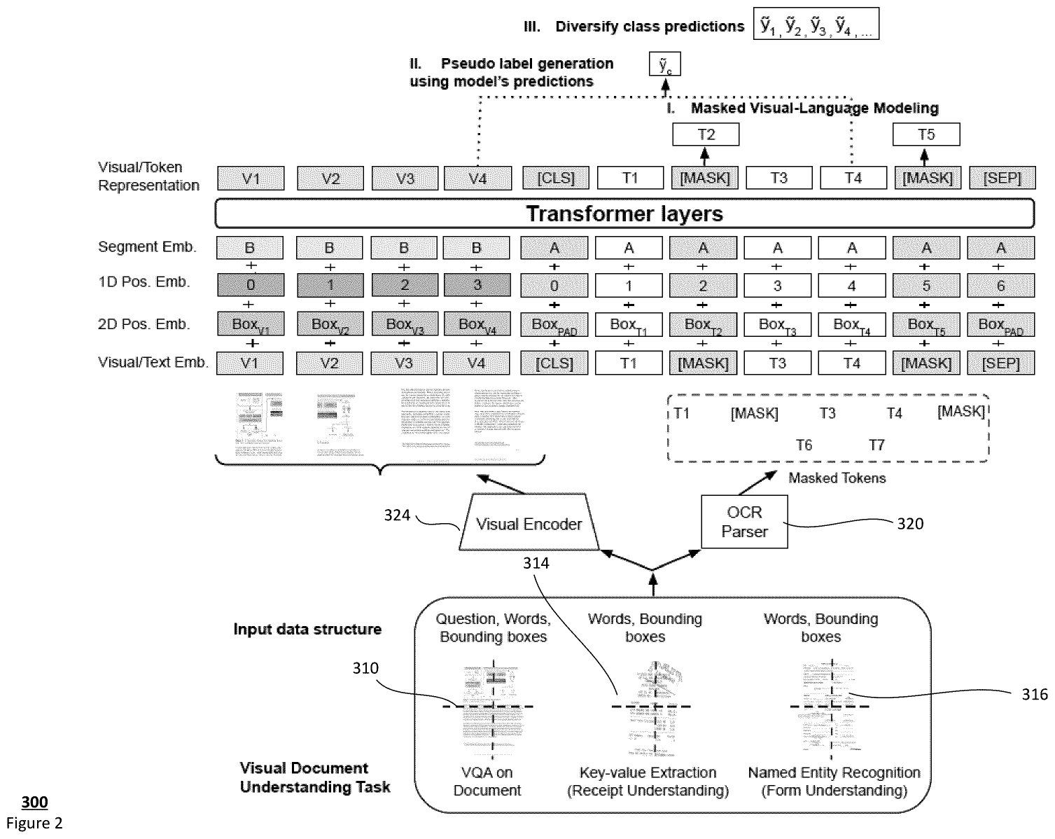

FIG. 2 illustrates a process flow 300 of DocTTA showing each of the objective functions applied in an example use case. As shown in FIG. 2, the input document may comprise a document of any one of the three visual document understanding tasks: VQA on Document 310, Key-value Extraction (e.g., Receipt Understanding) 314 and Named Entity Recognition (e.g., Form Understanding) 316. The OCR parser 320 is used to detect words which are then tokenized. The document image is also divided into multiple patches and passed to visual encoder 324 to detect bounding boxes. The MVLM algorithm as discussed above is then applied, followed by pseudo-label generation using the model's predictions and diversity class predictions (as also discussed above). More generally, in accordance with the disclosed technology, we want to i) learn how to predict masked language given visual cues, ii) generate pseudo-labels to supervise the learning, and iii) maximize the diversity of predictions to generate sufficient amount labels from all classes.

Unlike single-modality inputs commonly used in computer vision, documents are images with rich textual information. To extract the text from the image, we consider optical character recognition (“OCR”) is performed and use its outputs, characters, and their corresponding bounding boxes, as shown for instance via the example in FIG. 2. Input X is constructed in either of the domains composed of three components: text input sequence X^{T} of length n denoted as (x₁^{T}, . . . , xₙ^{T})∈ [symbol] ^{(n×d)}, image X^{I}∈R^{3×W×H}, and layout X^{B} as a 6-dimensional vector in the form of (xmin, xmax, ymin, ymax, w, h) representing a bounding box associated with each word in the text input sequence. Note that for the VQA task, the text input sequence is also prepended with the question. For the entity recognition task, labels correspond to the set of classes that denote the extracted text; for the key-value extraction task, labels are values for predefined keys; and for the VQA task, labels are the starting and ending positions of the answer presented in the document for the given question. We consider the closed-set assumption: the source and target domains share the same class labels Ys=Yt=Y with |Y|=C being the total number of classes.

In accordance with the disclosed technology, MVLM (Objective I) is employed at test-time to encourage the model to better learn the text representation of the test data given the 2D positions and other text tokens. The intuition behind using this objective for TTA is to enable the target model to learn the language modality of the new data given visual cues, thereby bridging the gap between the different modalities on the target domain. We randomly mask 15% of input text tokens, among which 80% are replaced by a special token [MASK] and the remaining tokens are replaced by a random word from the entire vocabulary. The model is then trained to recover the masked tokens while the layout information remains fixed. To do so, the output representations of masked tokens from the encoder are fed into a classifier which outputs logits over the whole vocabulary, to minimize the negative log-likelihood of correctly recovering masked text tokens x^{T} given masked image tokens x^{I} and masked layout [symbol] :

[symbol]

MVLM(θₜ)=− [symbol] ₓ_{ₜ}∈xₜΣₘ log p₀_{ₜ}(xₜ_{ₘ}^{T}|xₜ^{I}, [symbol] ) (1)

The second objective function comprises self-training with pseudo-labels (Objective II). While optimizing MVLM loss during the adaptation, we also generate pseudo-labels for the unlabeled target data and treat them as ground truth labels to perform supervised learning on the target domain. We generate pseudo-labels per batch aiming to use the latest version of the model for predictions. We consider a full epoch to be one training loop where we iterate over the entire dataset, batch-by-batch. In addition, using a clustering mechanism to generate pseudo-labels may be computationally expensive for documents. As such, we directly use predictions by the model. However, simply using all the predictions would lead to noisy pseudo-labels.

As such, in accordance with processing block 240 of FIG. 1, wet employ an uncertainty-aware selection mechanism to select the subset of pseudo-labels with low uncertainty. We empirically observe that raw confidence values (when taken as the posterior probability output from the model) are overconfident despite being right or wrong. Setting a threshold on pseudo-labels confidence may introduce a new hyperparameter without a performance gain. Instead, to select the predictions we propose to only use uncertainty, in the form of Shannon's entropy. We also expect this selection mechanism leads to reducing miscalibration due to the direct relationship between the ECE and output prediction uncertainty, e.g., when more certain predictions are selected, ECE is expected to reduce for the selected subset of pseudo-labels. Assume p⁽ⁱ⁾ be the output probability vector of the target sample x⁽ⁱ⁾ such that p_{c}⁽ⁱ⁾ denotes the probability of class c being the correct class. We select a pseudo-label [symbol] for xₜ⁽ⁱ⁾ uncertainty of the prediction u(p_{c}⁽ⁱ⁾), measured with Shannon's Entropy, is below a specific threshold γ and we update θₜ weights with a cross-entropy loss:

\tilde{y}_{c}ⁱ= [symbol] [u(p_{c}⁽ⁱ⁾)≤γ], (2)

[symbol]

_{CE}(θₜ)=− [symbol] ₓ_{ₜ}∈xₜ [symbol] \tilde{y}_{c} log σ(fₜ(xₜ)), (3)
where α(·) is the softmax function. It should be noted that the tokens that are masked for the MVLM loss are not included in the cross-entropy loss, as the attention mask for them is zero.

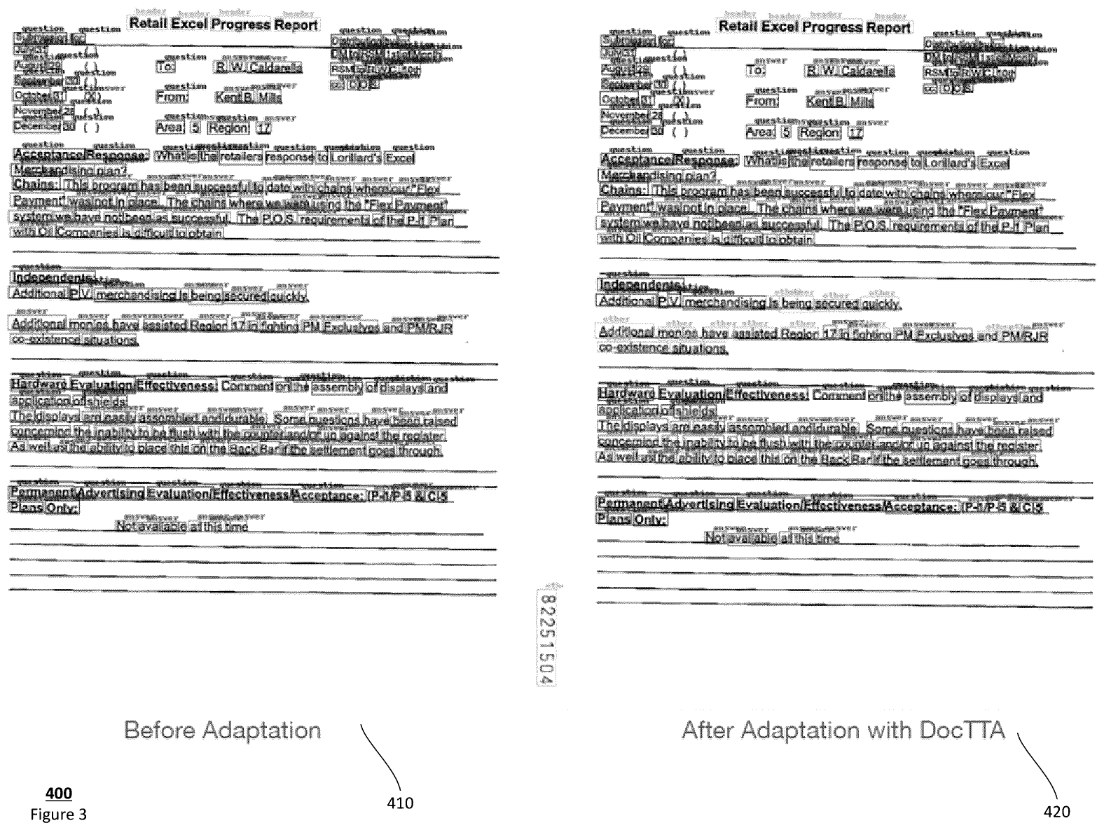

Turning now to the diversity objective function (Objective III of FIG. 3), to prevent the model from indiscriminately being dominated by the most probable class based on pseudo-labels, we encourage class diversification in predictions by minimizing the following objective:

[symbol]

_{DIV}= [symbol] ₓ_{ₜ}_{∈X}_{ₜ}Σ₀₌ₜ^{C}p̅ₓ log p̅_{c}, (4)

where p̅= [symbol] ₓ_{ₜ}_{∈X}_{ₜ}_{σ(f}_{ₜ}(xₜ)) is the output embedding of the target model averaged over target data. By combining Equations 1, 3, and 4, we obtain the full objective function in DocTTA as below:

[symbol]

_{DecTTA}= [symbol] _{MVLM}+ [symbol] _{CE}+ [symbol] _{D} (5)

In accordance with the foregoing, the DocTTA procedure can be formulated as the following algorithm:

Algorithm 1 DocTTA for closed-set TTA in VDU

| 1: | Input: Source model weights θ [symbol] , target documents [symbol] x [symbol] , test-time training epochs n [symbol] , test-time | |
|---|---|---|
| | training learning rate α, uncertainty threshold γ, questions for target documents in document VQA task | |
| 2: | Initialization: Initialize target model f_{θ}, with θ [symbol] weights. | |
| 3: | for epoch = 1 to n [symbol] do | |
| 4: | Perform masked visual-language modeling in Eq. 1 | |
| 5: | Generate pseudo labels and accept a subset using criteria in Eq. 2 and fine-tune with Eq. 3 | |
| 6: | Maximize diversity in pseudo label predictions Eq. 4 | |
| 7: | θ [symbol] ← θ [symbol] − α∇ [symbol] _{DocTTA} | [symbol] Update θ [symbol] via total loss in Eq. 5 |

| | |
|---|---|
| 8: | end for |

[symbol]

indicates data missing or illegible when filed

As indicated above, predictions are used by the model to determine pseudo-labels that are correct, as indicated at processing block 240 of FIG. 1. Specifically, all the predictions made by the model on all documents that are provided are used to compute the entropy based on a metric that is defined for the answers associated with the pseudo-labels that are generated. In this regard, the entropy is typically computed per prediction an done for all predictions. A threshold is then used to discard untrustworthy pseudo-labels. For example, threshold may cause 20% of the pseudo-labels to be discarded while the 80% that are kept are deemed correct.

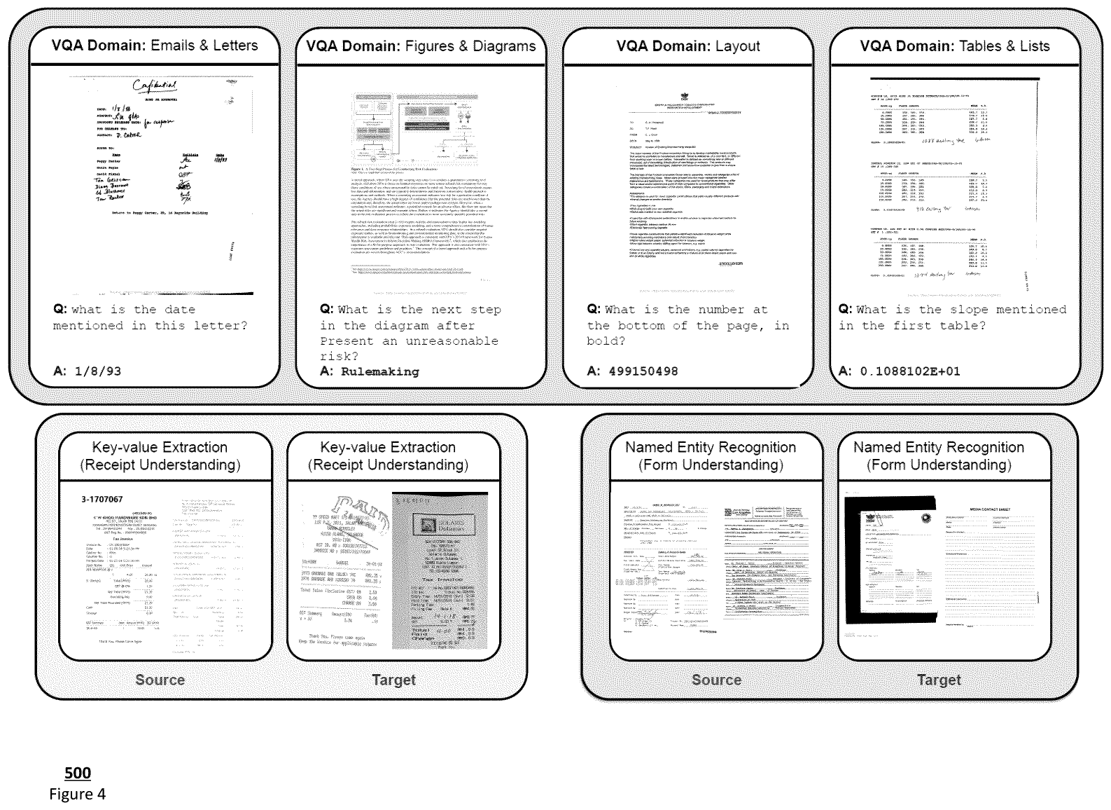

At block 250 of FIG. 2, the pseudo-labels that are kept (e.g., correct pseudo-labels) are used to label (or adapt) the input document or second data set. An example of document before adaptation (410) and after adaptation (420) is shown in FIG. 4. The adapted document or adapted second data set may be provided as output to a customer. In addition, pseudo-labels that are determined to be correct are fed back and used to train the document model.

In accordance with the process 1200, target streams containing unlabeled data may be processed seamlessly. This accounts for cases where a customer may have new data that was not accounted for during the training of the document model. In other cases, the amount of data available for training the model may be modest for certain customers and therefore such customers may have new data as a result of same and more frequently. The capability to adapt the document model and continue processing the input data stream improves processing by mitigating against unlabeled or unaccounted-for data causing the model to fail and associated computing systems to crash. In addition, the model is adapted without having to train the document model offline—with or without human intervention.

As indicated above, an aspect of the disclosed technology is the introduction of new benchmarks for VDU. Our benchmark datasets are constructed from existing popular and publicly-available VDU data to mimic real-world challenges.

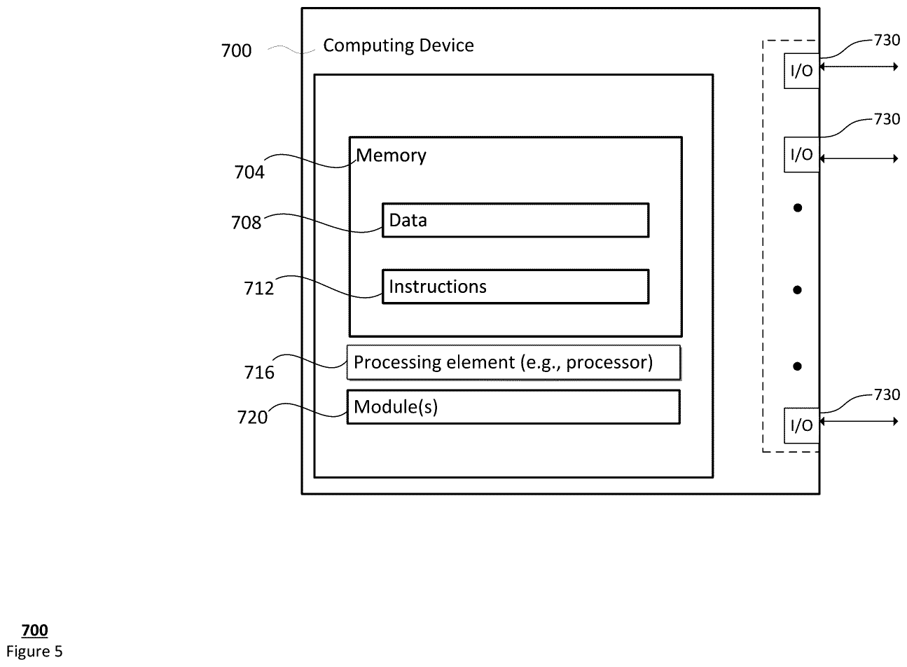

One benchmark is an entity recognition benchmark. We consider a Form Understanding in Noisy Scanned Documents (“FUNSD”) dataset for this benchmark, which is a noisy form understanding collection consists of sparsely-filled forms, with sparsity varying across the use cases the forms are from. In addition, the scanned images are noisy with different degradation amounts due to the disparity in scanning processes, which can further exacerbate the sparsity issue as the limited information might be based on incorrect OCR outputs. As a representative distribution shift challenge on FUNSD, we split the source and target documents based on the sparsity of available information measure. The original dataset has 9707 semantic entities and 31,485 words with 4 categories of entities question, answer, header, and other, where each category (except other) is either the beginning or the intermediate word of a sentence. Therefore, in total, we have 7 classes. We first combine the original training and test splits and then manually divide them into two groups. We set aside 149 forms that are filled with more texts for the source domain and put 50 forms that are sparsely filled for the target domain. We randomly choose 10 out of 149 documents for validation, and the remaining 139 for training. FIG. 5 (bottom row on the right) shows examples from the source and target domains.

Another benchmark is a key-value extraction adaptation benchmark. We use Scanned Receipts OCR and Information Extraction (“SROIE”) dataset with 9 classes in total. Similar to FUNSD, we first combine the original training and test splits. Then, we manually divide them into two groups based on their visual appearance—source domain with 600 documents contains standard-looking receipts with proper angle of view and clear black ink color. We use 37 documents from this split for validation, which we use to tune adaptation hyperparameters. Note that the validation split does not overlap with the target domain, which has 347 receipts with slightly blurry look, rotated view, colored ink, and large empty margins. FIG. 5 (bottom row on the left) exemplifies documents from the source and target domains.

Another benchmark is a document VQA benchmark. We use DocVQA, a large-scale VQA dataset with nearly 20 different types of documents including scientific reports, letters, notes, invoices, publications, tables, etc. The original training and validation splits contain questions from all of these document types. However, for the purpose of creating an adaptation benchmark, we select 4 domains of documents: i) Emails & Letters (E), ii) Tables & Lists (T), iii) Figure & Diagrams (F), and iv) Layout (L). Since DocVQA doesn't have public meta-data to easily sort all documents with their questions, we use a simple keyword search to find our desired categories of questions and their matching documents. We use the same words in domains' names to search among questions (i.e., we search for the words of “email” and “letter” for Emails & Letters domain). However, for Layout domain, our list of keywords is [“top”, “bottom”, “right”, “left”, “header”, “page number”] which identifies questions that are querying information from a specific location in the document. Among the four domains, L and E have the shortest gap because emails/letters have structured layouts and extracting information from them requires understanding relational positions. For example, the name and signature of the sender usually appear at the bottom, while the date usually appears at top left. However, F and T domains seem to have larger gaps with other domains, that we attributed to learning to answer questions on figures or tables requires understanding local information within the list or table. FIG. 5 (top row) exemplifies some documents with their questions from each domain.

FIG. 5 depicts an example of computing device 700 that may be used to carry out various aspects of the disclosed technology. For example, the computing device 700 may be used to implement the processes discussed above, including the process depicted in FIG. 1, and the various processing associated with the components and modules discussed in FIGS. 1 through 3.

The computing device 700 can take on a variety of configurations, such as, for example, a controller or microcontroller, a processor, or an ASIC. In some instances, computing device 700 may comprise a server or host machine that carries out the operations discussed above. In other instances, such operations may be performed by one or more of the computing devices in a data center. The computing device may include memory 704, which includes data 708 and instructions 712, and a processing element 716, as well as other components typically present in computing devices (e.g., input/output interfaces for a keyboard, display, etc.; communication ports for connecting to different types of networks).

The memory 704 can store information accessible by the processing element 716, including instructions 712 that can be executed by processing element 716. Memory 704 can also include data 708 that can be retrieved, manipulated, or stored by the processing element 716. The memory 704 may be a type of non-transitory computer-readable medium capable of storing information accessible by the processing element 716, such as a hard drive, solid state drive, tape drive, optical storage, memory card, ROM, RAM, DVD, CD-ROM, write-capable, and read-only memories. The processing element 716 can be a well-known processor or other lesser-known types of processors. Alternatively, the processing element 716 can be a dedicated controller such as an ASIC.

The instructions 712 can be a set of instructions executed directly, such as machine code, or indirectly, such as scripts, by the processor 716. In this regard, the terms “instructions,” “steps,” and “programs” can be used interchangeably herein. The instructions 712 can be stored in object code format for direct processing by the processor 716, or can be stored in other types of computer language, including scripts or collections of independent source code modules that are interpreted on demand or compiled in advance. For example, the instructions 712 may include instructions to carry out the processes, methods, and functions discussed above in relation to FIGS. 1-2.

The data 708 can be retrieved, stored, or modified by the processor 716 in accordance with the instructions 712. For instance, although the system and method are not limited by a particular data structure, the data 708 can be stored in computer registers, in a relational database as a table having a plurality of different fields and records, or in XML documents. The data 708 can also be formatted in a computer-readable format such as, but not limited to, binary values, ASCII, or Unicode. Moreover, the data 708 can include information sufficient to identify relevant information, such as numbers, descriptive text, proprietary codes, pointers, references to data stored in other memories, including other network locations, or information that is used by a function to calculate relevant data.

FIG. 5 functionally illustrates the processing element 716 and memory 704 as being within the same block, but the processing element 716 and memory 704 may instead include multiple processors and memories that may or may not be stored within the same physical housing. For example, some of the instructions 712 and data 708 may be stored on a removable CD-ROM and others may be within a read-only computer chip. Some or all of the instructions and data can be stored in a location physically remote from, yet still accessible by, the processing element 716. Similarly, the processing element 716 can include a collection of processors, which may or may not operate in parallel.

The computing device 700 may also include one or more modules 720. Modules 720 may comprise software modules that include a set of instructions, data, and other components (e.g., libraries) used to operate computing device 700 so that it performs specific tasks. For example, the modules 720 may comprise scripts, programs, or instructions to implement one or more of the functions associated with the modules or components discussed in FIGS. 1 through 3. The modules 720 may comprise scripts, programs, or instructions to implement the process flow in FIGS. 1 through 2.

Computing device 700 may also include one or more input/output ports 730. Each I/O port 730 may receive an input stream as discussed above and after processing output the data stream updated with pseudo-labels. Each output port may comprise an I/O interface that communicates with local and wide area networks.

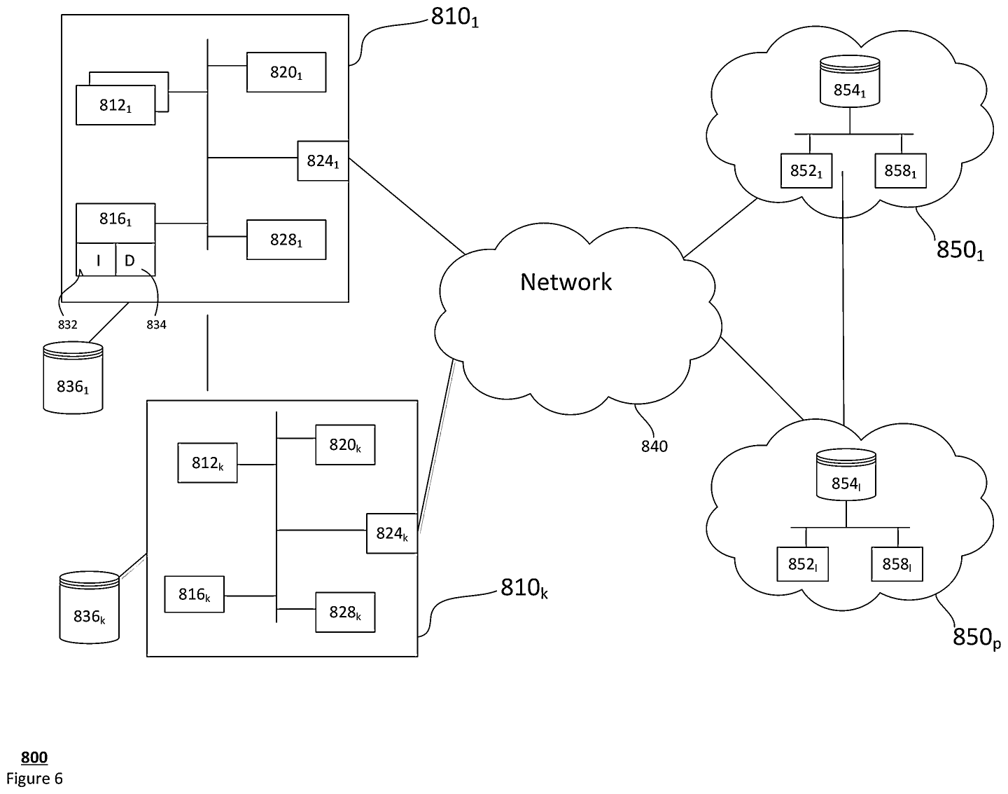

In some examples, the disclosed technology may be implemented as a system 800 in a distributed computing environment as shown in FIG. 6. System 800 includes one or more computing devices 810, which may comprise computing devices 8101 through 810k, storage 836, a network 840, and one or more cloud computing systems 850, which may comprise cloud computing systems 8501 through 850p. Computing devices 810 may comprise computing devices located at a customer location that makes use of cloud computing services such as Infrastructure as a Service (IaaS), Platform as a Service (PaaS), and/or Software as a Service (SaaS). For example, if a computing device 810 is located at a business enterprise, computing device 810 may use cloud systems 850 as a service that provides software applications (e.g., accounting, word processing, inventory tracking, etc., applications) to computing devices 810 used in operating enterprise systems. In addition, computing device 810 may access cloud computing systems 850 as part of its operations to perform semantic queries of video, audio, or image data in support of its business enterprise.

Computing device 810 may comprise a computing device as discussed in relation to FIG. 6. For instance, each of computing devices 810 may include one or more processors 812, memory 816 storing data 834 and instructions 832, display 820, communication interface 824, and input system 828. The processors 812 and memories 816 may be communicatively coupled as shown in FIG. 6. Computing device 810 may also be coupled or connected to storage 836, which may comprise local or remote storage, e.g., on a Storage Area Network (“SAN”), that stores data accumulated as part of a customer's operation. Computing device 810 may comprise a standalone computer (e.g., desktop or laptop) or a server associated with a customer. A given customer may also implement, as part of its business, multiple computing devices as servers. Memory 816 stores information accessible by the one or more processors 812, including instructions 832 and data 834 that may be executed or otherwise used by the processor(s) 812. The memory 816 may be of any type capable of storing information accessible by the processor, including a computing device-readable medium, or other medium that stores data that may be read with the aid of an electronic device, such as a hard drive, memory card, ROM, RAM, DVD or other optical disks, as well as other write-capable and read-only memories. Systems and methods may include different combinations of the foregoing, whereby different portions of the instructions and data are stored on different types of media.

Computing device 810 may also include a display 820 (e.g., a monitor having a screen, a touch-screen, a projector, a television, or other device that is operable to display information) that provides a user interface that allows for controlling the computing device 810. Such control may include, for example, using a computing device to cause data to be uploaded through input system 828 to cloud system 850 for processing, causing accumulation of data on storage 836, or more generally, managing different aspects of a customer's computing system. While input system 828 may be used to upload data, e.g., a USB port, computing system 800 may also include a mouse, keyboard, touchscreen, or microphone that can be used to receive commands and/or data.

The network 840 may include various configurations and protocols, including short-range communication protocols such as Bluetooth™, Bluetooth LE, the Internet, World Wide Web, intranets, virtual private networks, wide area networks, local networks, private networks using communication protocols proprietary to one or more companies, Ethernet, WiFi, HTTP, etc., and various combinations of the foregoing. Such communication may be facilitated by any device capable of transmitting data to and from other computing devices, such as modems and wireless interfaces. Computing device 810 interfaces with network 840 through communication interface 824, which may include the hardware, drivers, and software necessary to support a given communications protocol.

Cloud computing systems 850 may comprise one or more data centers that may be linked via high speed communications or computing networks. A given data center within system 850 may comprise dedicated space within a building that houses computing systems and their associated components, e.g., storage systems and communication systems. Typically, a data center will include racks of communication equipment, servers/hosts, and disks. The servers/hosts and disks comprise physical computing resources that are used to provide virtual computing resources such as VMs. To the extent that a given cloud computing system includes more than one data center, those data centers may be at different geographic locations within relative close proximity to each other, chosen to deliver services in a timely and economically efficient manner, as well as provide redundancy and maintain high availability. Similarly, different cloud computing systems are typically provided at different geographic locations.

As shown in FIG. 6, computing system 850 may be illustrated as comprising infrastructure 852, storage 854, and computer system 858. Infrastructure 852, storage 854, and computer system 858 may comprise a data center within a cloud computing system 850. Infrastructure 852 may comprise servers, switches, physical links (e.g., fiber), and other equipment used to interconnect servers within a data center with storage 854 and computer system 858. Storage 854 may comprise a disk or other storage device that is partitionable to provide physical or virtual storage to virtual machines running on processing devices within a data center. Storage 854 may be provided as a SAN within the datacenter hosting the virtual machines supported by storage 854 or in a different data center that does not share a physical location with the virtual machines it supports. Computer system 858 acts as supervisor or managing agent for jobs being processed by a given data center. In general, computer system 858 will contain the instructions necessary to, for example, manage the operations requested as part of a synchronous training operation on customer data. Computer system 858 may receive jobs, for example, as a result of input (e.g., a search request) received via an application programming interface (“API”) from a user, searcher, or customer.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
training, via a source domain, a machine learning model to use with one or more visual document understanding (“VDU”) tasks;
determining a distribution shift when the machine learning model is applied in a target domain;
applying a masked visual language modeling (“MVLM”) to target domain data determined as associated with the distribution shift to produce model predictions;
generating pseudo-labels using the model predictions; and
adapting the machine learning model to include the pseudo-labels to produce an adapted model.

2. The method of claim 1, comprising applying self-training to the machine learning model using the pseudo-labels.

3. The method of claim 1, comprising processing the target domain data detected as associated with the distribution shift using the adapted model.

4. The method of claim 1, comprising applying thresholding to the pseudo-labels to reduce the pseudo-labels by a given amount.

5. The method of claim 4, wherein the applying a threshold comprises applying an entropy-based uncertainty-aware pseudo-labeling selection mechanism to determine which of the pseudo-labels are reliable.

6. The method of claim 1, comprising generating the pseudo-labels on a per-batch basis.

7. The method of claim 1, comprising processing the target domain data using a visual encoder.

8. The method of claim 7, comprising processing the target domain data using an optical character recognition parser.

9. A method for processing one or more electronic documents, comprising:
receiving the one or more electronic documents as an input data stream;
applying a machine learning model to the input data stream;
determining that there is a domain shift associated with the input data stream;
applying masked visual language modeling (“MVLM”) to target domain data determined as associated with the domain shift to produce model predictions;
generating pseudo-labels using the model predictions;
adapting the machine learning model to include the pseudo-labels to produce an adapted model; and
processing the input data stream using the adapted model.

10. The method of claim 9, wherein the machine learning model is trained on source domain data that does not account for the target domain data.

11. The method of claim 9, comprising applying self-training to the machine learning model using the pseudo-labels.

12. The method of claim 9, comprising applying threshold to the pseudo-labels to reduce the pseudo-labels by a given amount.

13. The method of claim 12 wherein the applying the threshold comprises applying an entropy-based uncertainty-aware pseudo-labeling selection mechanism to determine which of the pseudo-labels are reliable.

14. The method of claim 9, comprising generating the pseudo-labels on a per-batch basis.

15. The method of claim 9, comprising processing the target domain data using a visual encoder.

16. The method of claim 9, comprising processing the target domain data using an optical character recognition parser.

17. The method of claim 9, wherein the target domain data comprises test-time data.

18. A non-transitory computer readable medium having stored thereon instructions that when executed by one or more computing devices cause the one or computing devices to:
determine a distribution shift when the machine learning model is applied in a target domain;
apply a masked visual language modeling (“MVLM”) to target domain data detected as associated with the distribution shift to produce model predictions;
generate pseudo-labels using the model predictions; and
adapt the machine learning model to include the pseudo-labels to produce an adapted model.

19. The non-transitory computer readable medium of claim 18, wherein the instructions cause the one or computing devices to apply self-training to the machine learning model using the pseudo-labels.

20. The non-transitory computer readable medium of claim 18, wherein the instructions cause the one or computing devices to process the target domain data detected as associated with the distribution shift using the adapted model.
